(19) United States
(12) Patent Application Publication
(10) Pub. No.: US 2008/0177678 A1
(43) Pub. Date: Jul. 24, 2008

(54) METHOD OF COMMUNICATING BETWEEN A UTILITY AND ITS CUSTOMER LOCATIONS

(76) Inventors: Paul Di Martini, North Tustin, CA (US); Muir Davis, La Verne, CA (US); Stephanie L. Hamilton, Monrovia, CA (US); Paul G Kasick, Los Angeles, CA (US); Russell Neal, Hantington Beach, CA (US); Lester Hirata, Fontana, CA (US); Mark Martinez, La Canada Flintridge, CA (US); Robert G. Woods, Huntington Beach, CA (US); Victor Pimentel, Rancho Cucamonga, CA (US); Bob Yinger, Seal Beach, CA (US); Syd Nagoshl, Whittier, CA (US); James McGrath, Fontana, CA (US); Mark B. Reardon, San Marcos, CA (US); Cathy Melton, Placentia, CA (US); Debbie Tillman, Lakewood, CA (US); Larry Colwell, Upland, CA (US); John Bubb, Newport Beach, CA (US); Thomas J. Dossey, Covina, CA (US); Jeremy Laundergan, Long Beach, CA (US); Jeff Gooding, Upland, CA (US); Kevin G Wood, Glendora, CA (US)

Correspondence Address: SHELDON MAK ROSE & ANDERSON PC, 100 Corson Street, Third Floor, PASADENA, CA, 91103-3842, US

(21) Appl. No.: 11/626,810

(22) Filed: Jan. 24, 2007

(51) Int. Cl. G08C 15/06; G06Q 10/00; G08B 25/00

(52) U.S. Cl. 705/412; 340/870.02; 705/1

(57) ABSTRACT

A method for communicating between a utility and individual customer locations includes the step of communicating between the utility and customers and between the utility and customer equipment located at each individual customer location via the Internet or via an advanced utility meter. The method of communicating typically includes the additional steps of providing each individual customer location with an advanced utility meter and using each individual utility meter to communicate between the utility and the advanced utility meter, to communicate between the advanced utility meter and the individual customers and to communicate between the advanced utility meter and equipment locator and each individual customer location.

### SUMMARY

The invention is a method for communicating between a utility and individual customer locations. In the method, communications between the utility and the utility's customer and between the utility and customer equipment located at each of the utility's individual customer locations are accomplished via the Internet or via an advanced utility meter.

In one embodiment of the invention, the method comprises the steps of providing each individual customer location with an advanced utility meter and using each such individual utility meter to communicate between the utility and the advanced utility meter, between the advanced utility meter and individual customers and between the advanced utility meter and equipment located at each individual customer location. In this method of the invention, a unique system can be employed whereby the system comprises (a) individual input and output portals disposed at each individual customer location; (b) a data center aggregator for gathering data from each individual customer location and for retransmission to the utility, and for disseminating data and instructions from the utility to each customer location; (c) a data management system for sorting data from the data center aggregator, for transmitting data to individual back office systems within the utility and for transmitting data and instructions from individual back office systems to each individual customer location; and (d) means for communicating between the utility, the data center aggregator, the data management system and the input and output portals disposed at individual customer locations.

### DRAWINGS

These and other features, aspects and advantages of the present invention will become better understood with reference to the following description, appended claims and accompanying drawings where:

FIG. 1 is a diagram illustrating the use of an advanced utility meter in the method of the invention;

FIG. 2 is a diagram illustrating a system having features of the invention and further illustrating typical communication routes to and from the advanced utility meter;

FIG. 3 is a diagram further illustrating typical communication routes to and from the advanced utility meter;

FIG. 4 is a diagram illustrating typical circuitry surrounding the advanced utility meter; and

FIG. 5 is a diagram illustrating how the circuitry illustrated in FIG. 4 communicates with a utility employing the invention.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a method for communicating between a utility and individual customer locations. The method comprises the step of communicating between the utility and customers and between the utility and customer equipment located at each individual customer location via the Internet or via an advanced utility meter.

Typically, each individual customer location is provided with an advanced utility meter. Each individual utility meter is used to communicate between the utility and the advanced utility meter, between the advanced utility meter and individual customers and between the advanced utility meter and equipment located at each individual customer location. Usage, billing and cost data can be communicated between each advanced utility meter and each customer.

Typically, the advanced utility meter communicates between the utility and multiple appliances and/or other pieces of equipment located at each individual customer location. In a preferred embodiment of the invention, usage data from individual pieces of equipment located at each individual customer location is gathered to the advanced utility meter and transmitted to the utility by the advanced utility meter.

Preferably, each advanced utility meter comprises storage means for storing data.

The method allows for the collection and communication of real time data from each customer location to the utility. Typically, collection of such real time data is accomplished at least as often as once per hour and transmission from the individual customer locations to the utility is accomplished at least as often as once per day.

In an embodiment of the invention wherein the utility is an electrical utility, instructions can be communicated from the utility to the individual customer locations which are used by usage controllers at the individual customer locations to control electrical usage by individual pieces of equipment at the individual customer locations.

The advanced utility meter can also comprise a remote service connect/disconnect switch which can be used to remotely connect or disconnect the individual customer location from the services provided by the utility. In a related embodiment, a service limiting activation/deactivation device can be used to remotely limit, without wholly curtailing, services provided by the utility.

In another embodiment of the method, the advanced utility meter can be used to communicate upgrades and maintenance directives to software at the individual customer locations, such as communications software, monitoring software, storage software or controller software.

Typically, two-way communication is established with each individual customer via the method of the invention. Communication with the utility's individual customers is typically accomplished via a display device which can be a monitor screen or other visual or audio signal device located at the individual customer locations.

In many embodiments of the invention, communication within the method is accomplished via wireless communications equipment.

In one embodiment, the method of the invention employs a unique system 8 for communicating between a utility 10 and individual customer locations 12. The system 8 comprises (a) individual input and output portals 14 disposed at each individual customer location 12, (b) a utility gateway 16, including a data center aggregator 18, for gathering data from each individual customer location 12 and for re-transmitting that data to the utility 10 and also for disseminating data and instructions from the utility 10 to each customer location 12, (c) a data management system 20 for sorting data from the data center aggregator 18, for transmitting data to individual back office systems within the utility 10 and for transmitting data and instructions from the individual back offices within the utility 10 to each individual customer location 12, and (d) means 22 for communicating between the utility 10, the data center aggregator 18, the cost data management system 20 and the input and output portals 14 disposed at individual customer locations 12. Typically, the input and output portals 14 located at individual customer locations 12 comprise a portion of an advanced utility meter 24 disposed at each individual customer location 12. In one embodiment of this system, the means for communicating between the utility 10, the data center aggregator 18, the data management system 20 and the input and output portals 14 comprises the Internet.

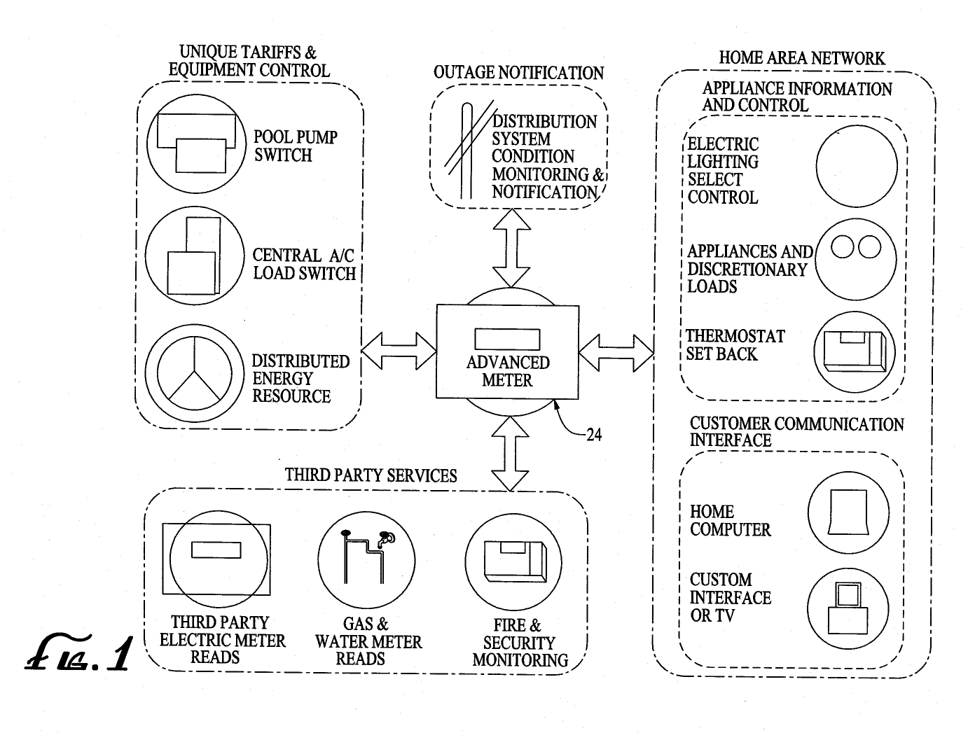

As noted above, the invention typically comprises the use of an advanced utility meter disposed on the premises of each of the utility's consumers. Unlike advanced utility meters of the prior art, the advanced utility meter is capable of gathering usage information regarding individual appliances or groups of appliances operated by the consumer and continuously, or at least frequently, transferring that data electronically to different back office control centers within the utility. Thus, the advanced utility meter acts as a gateway to specific equipment and systems on the premises of each consumer in conjunction with data acquisition, process and storage systems controlled by the utility and authorized third parties. As illustrated in FIG. 1, the advanced utility meter can be used, for example, to monitor and/or control such equipment and systems as a central air conditioning system, pool pumps, thermostats, refrigerators, washing machines, gas & water meters, and spare appliances for residential customers and A/C plant, refrigeration, lighting, motors and controls, etc. for commercial customers.

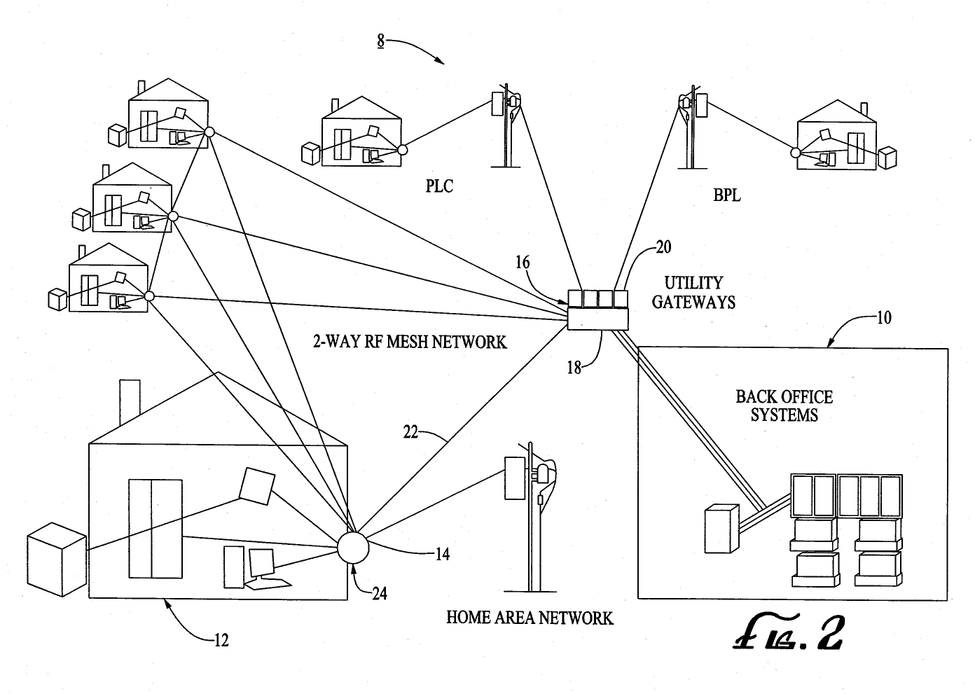

As illustrated in FIG. 2, data gathered by each advanced utility meter via, for example, home area networks, can be continuously, or at least frequently, transmitted to intermediate utility gateways (not shown) via any of a number of known electronic methods. From each intermediate utility gateway, the data is transmitted to the utility gateway 16, and then directly to the utility where it is available to each utility back office operating department for use in operating the many aspects of the utility.

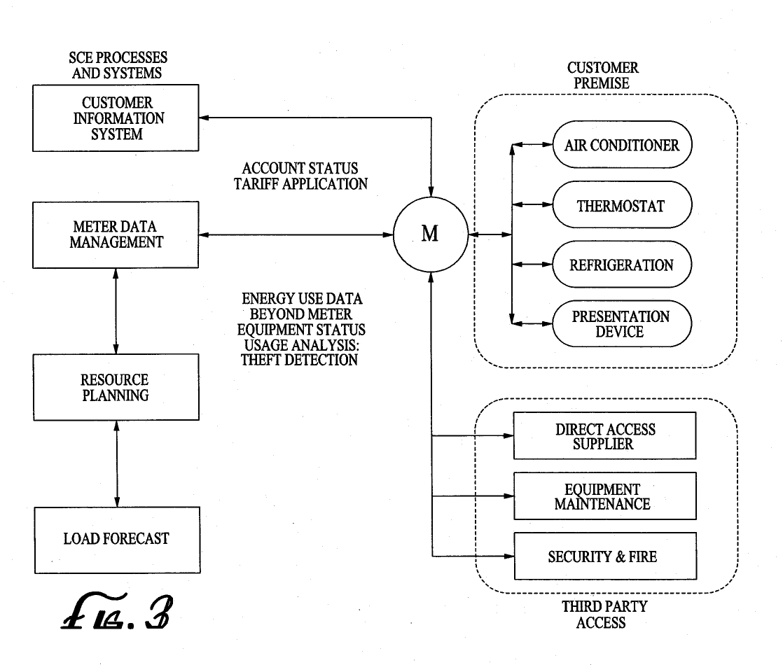

FIG. 3 illustrates the two-way flow of information in the method of the invention between the customer, the utility and other authorized entities.

The method of the invention can be advantageously used to communicate between any utility and its individual customer locations. The method of the invention is ideally suited for use by an electrical utility to communicate with its individual customer locations. Those of skill in the art will recognize that the method of the invention can be easily modified to facilitate communications between other types of utilities and their individual customer locations.

For an electrical utility, optimizing the behavior of the power system involves many issues related to feeder loading, voltage profiles, efficiency, reliability, quality and others. Using the information that the method of the invention can provide, in addition to already existing systems, can improve the quality and efficiency of network optimization.

For example, power system applications exist in many varieties. The most important ones that can benefit from information provided by the method of the invention and that can use the method of the invention to improve their performance include:
Loss Analysis
Fault Location, Isolation and Service Restoration
Contingency Analysis
Feeder Reconfiguration
Load shedding and load curtailment
Protection Re-coordination
Voltage and VAR Control
Pre-arming of Remedial Action Schemes
Intelligent Alarm Processing
Transformer voltage regulation
Load forecasting and state estimation
Automatic feeder and capacitor bank switching
Power Quality Monitoring and Reporting
Power Quality Contract Compliance

Possible outputs from the method of the invention on behalf of these functions include:
real time voltage
real time current
power consumption by time interval
average voltage at customer site
voltage variations seen by the customer
harmonics (voltage and/or current)
power production by customer-supplied distributed generation
customer power factor

These applications can be separated into two categories—on-line and off-line. The on-line category can be considered a classification of real-time monitoring and control. Examples of this category include alarming, volt/VAR control, and fault location. The off-line category involves evaluation of information gathered by the method of the invention system from a historical perspective.

Applications of this type generally retrieve data from a data historian that is periodically populated with new data from the method of the invention. Examples of this category include feeder optimization, load forecasting, and power quality contract compliance.

The method of the invention has the capability to diagnose its own components, including components involved in the collection of device health indications, remote diagnostics, and optimizing operating parameters. Problems with advanced utility meters are detected by the method of the invention, Data Center Concentrator (DCC), the Customer, the Utility's field workforce. System intelligence regarding analyzing data to determine if a trouble report and visit to the advanced utility meter is required reduces the number of unnecessary meter visits. When problems are identified they will normally result in the replacement of the advanced utility meter, with the possible exception of certain minor repairs that can be safely handled in the field.

Additionally, while most meter upgrades will be performed automatically it may be necessary for a Utility to dispatch a member of its field workforce to directly perform preventative or upgrade maintenance on installed equipment. The ability of the advanced utility meter to perform its own self diagnostic testing and to transmit the results to a remote user allows for determination of whether or not the meter needs to be replaced before the Utility has to dispatch a Installer and helps to reduce the number of erroneous premise visits and meter replacements.

One of the key tools for the Utilities field workforce is a self-contained workstation “field tool” that will permit authorized personnel to perform high speed downloading of information from the advanced utility meter. This information will include usage data as well as various event logs. This “field tool” will also be able to communicate with the meter during meter installation (and provisioning) and will automatically record information about the meter being removed (in the case of an advanced utility meter) and the meter being installed. This information will be used to complete the “trouble” ticket as well as updating the Meter Management System at either the completion of the repair process or at an appropriate time during the day. The ability of this tool to automatically obtain and process information will ensure that the Meter Management System and “trouble” orders are updated in a timely and highly accurate manner eliminating lost updates and vastly reducing inaccuracies in the information used by the business.

The following is a discussion of how the method of the invention can be used to communicate between an electrical utility and its individual customer locations. Those of skill in the art will recognize that the method of the invention can be easily modified to facilitate communications between other types of utilities and their individual customer locations.

### Billing and Customer Service

### Customer Account Management in an Electrical Utility

Existing processes for customer account management have typically been multi-step, requiring a service request be generated, and then often requiring inspection of the physical premises to confirm status. Information about energy use is typically not available until the first billing cycle.

However, in the method of the invention, the customer service initiation process can be compressed to real time by providing the utility service representative with the ability to initiate a service request, confirm account location, check meter status (on/off), check applicable tariffs and determine any outstanding billing issues in one session. In this aspect of the invention, the utility monitors and flags abnormal or unexpected use given the account status and provides immediate feedback (e.g. a few days) if use is outside of expected parameters. Also, in the method of the invention, deployed equipment will execute self-diagnostics, report its current deployment status (location, operational status, etc.) and its customer account association.

For example, existing procedures for customer connection and disconnection fall into two major categories, “hard” connections/disconnections and “soft” connections/disconnections. In both cases, a service disconnect represents a change in service status for the affected account. This typically requires a service order from the utility's accounting department following a cancellation request from the customer or an internal request for disconnect from the accounting department due to a no-pay situation. In many cases, particularly for residential premises which experience frequent turn-over such as multi-tenant residential sites and single family rental units, the utility will currently use a “soft disconnect” which is simply a process of identifying the specific meter location and account as “inactive” and thus not billed. The “soft disconnect” is essentially an accounting process and involves no physical action at the site and avoids sending a meter technician into the field to make a physical disconnect. The approach is effective in situations where there is a reasonable expectation of a short duration of service interruption and avoids the cost of deploying meter service personnel. The risk of this approach is that idle use of energy still occurs at the site. It is expected that idle usage is small, but the situation is still vulnerable to tampering and unauthorized electric use beyond the still-active meter.

A hard disconnect involves physically removing or disabling the utility electric meter at the customer site and is generally associated with sites where the expected service interruption is longer or the service disconnect is the result of a no-pay situation in which case service must be physically interrupted to assure no unauthorized use. The hard disconnect requires deployment of a meter service technician.

The method of the invention can be used to control the connectivity of individual customers. This function can be accomplished by controlling a “switch” between the customer load and the distribution supply system. This switch can be an integral part of the advanced utility meter, but that is not required. The utility can base connect/disconnect decisions on a variety of criteria. Examples include:
Routine move-in/move-out.
Disconnect upon lack of customer payment or via confirmed customer request
Reconnect upon resumption of payment
Disconnect upon load greater than customer allowance

The scheduling of field resources to visit the customer sites is complex and costly, and occasionally the activity cannot be carried out at the time that the customer wanted. Termination of service in support of credit and collections activities requires a “physical” interruption of services until appropriate financial arrangements are made to demonstrate that the customer will honor their obligations. Credit and collection service termination orders inherently carry with them the possibility of physical risk to the field technicians. The efficiencies provided by remote connect/disconnect include less man hours on site, shorter customer phone call activity, in addition, with the present metering systems deployed for residential and small/medium commercial customers there is no ability to limit load in response to constrained supply, credit issues, or where the customer desires to set a “maximum” load limit for a site.

Thus, utilities can improve the efficiency of the service initiation/termination processes through remote turn on/off functions, and can remotely limit usage/load, particularly as a mitigating response to constrained supply and credit & collections issues. Some of the business transactions that can use the method of the invention in this regard:
Routine shut-off of service (move out)
Routine turn-on of service (move in)
Credit & Collections termination of service
Credit & Collections reinstatement of service
Local/on site shut-off of service
Local/on site turn-on of service
Credit and Collection Service Limiting

Thus, by the method of the invention, the existing process of “soft” and “hard” disconnects ceases to exist and is replaced with a more robust concept and process of account service management. The customer service request process changes to a real-time process where the account status is modified by a utility customer service representative by changing the status of the advanced utility meter at the customer location. The concept of service being either “on” or “off” is thus modified to allow the utility to establish various “degrees” of service at the location via enabling full use, suspending use entirely or curtailing use to some pre-specified level (e.g. life line levels, pre-pay or “pay as you go” modes).

The advanced utility meter can also be used to autonomously make the disconnect decision based upon criteria such as a load threshold. This scenario excludes the mechanism used by the utility to trigger the connect/disconnect command or mechanism which control the determination of load set-points.

Another way of using the invention to manage customer accounts arises from the facilitation of customer incentive plans. For example, a customer of a utility can enroll in a program in which he or she will be compensated for connecting specific energy-saving or load shifting devices to his service. The customer is informed of utility-approved devices. The customer enrolls the devices using an automated system. The devices identify themselves to the meter. The meter then reports to the system of the method of the invention how many and what types of devices are installed in order for the customer to receive credit. The automated system reduces the cost to enable the customer HAN devices, increases customer participation, and improves the customer experience.

The devices use a variety of means to identify themselves to the meter. Some communicate using a simple power line carrier (PLC) protocol that the meter can be taught to use by downloading a new program to its digital signal processing (DSP) chip. Others use a ZigBee wireless home area network.

As new HAN technology is developed over the years, a customer may purchase a new device with new HAN technology which the method of the invention does not recognize. The customer will then be notified that they must either pay the Utility to change the advanced utility meter (or service gateway) to one that accommodates the new HAN technology or to install a “bridge” to convert the device to the old HAN technology (if available). Forward and backward compatibility with the communications technology ensures that both the Customer's and Utility's investment is protected.

### Development and Application of Tariffs

Existing processes for assigning tariff(s) to a customer account rely on physical location and historic use patterns. Current end use metering provides customer energy use information that is non-discriminate. In other words, total consumption measured by an existing utility meter does not shed any light on how the energy is being used beyond the meter. Utility tariffs have been designed and applied based on average and expected conditions for each customer within a customer class. This approach trades off the potential value of applying more detailed, specific or unique tariffs tied more directly to specific energy use beyond the meter with a more generalized “averaging” or application by customer class which is has been more economically manageable given the technologies available. These customer class-based tariff structures limit the utility's ability to provide incentives to customers to respond to economic signals and make more rational energy use choices.

In the method of the invention, however, new processes support the dynamic application of tariffs based on the large additional information obtained at the site via the advanced utility meter. The advanced utility meter can report energy use and patterns and sense equipment types and loads beyond the meter to flag use of the proper tariff and any opportunities for the customer to take advantage of new available tariffs based on use and customer equipment. This application is thus driven more by customer selection than by application of narrowly defined utility rules.

For example, in the method of the invention, multiple tariffs can be used at a single customer site. This is enabled by the multi-channel capability of the advanced utility meter that tracks energy consumption of specific equipment or beyond-the-meter circuits and allows for application of a specific tariff tied to that usage.

Existing tariffs are constrained to a particular billing cycle. In the method of the invention, the customer is allowed to select a billing period that best suits his or her needs. Energy use information can be gathered at any frequency and the customer billing information is presented via a customer interface in the advanced utility meter.

In the method of the invention, the advanced utility meter tracks energy consumption of specific equipment or beyond the meter circuits in real time and allows for application of a specific tariff tied to that usage. Energy use can be measured at any appropriate interval frequency and timing (e.g. 15 minute intervals during summer on peak periods and 1 hour intervals for summer partial and off peak periods and all winter periods) for the tariff or program. In the invention, 2-way communication and control capability is provided. This functionality provides for control of beyond-the-meter equipment as part of load control or curtailment programs and is tied to dynamic tariff applications depending upon the responsiveness or performance under a specific load management program. For example, a customer can be allowed to participate in a load management program that provides for an economically attractive special tariff in exchange for the utility being able to control the A/C on the site. If the A/C is available and performs as required when requested, then the program tariff is used in calculating the customer bill for the period. If the equipment does not respond as required when directed, then an alternative tariff is applied for the period.

### Measuring Use, Billing and Payment Collection

A basic concept behind the method of the invention is the ability to collect information from the customer meter. The data collected by each advanced utility meter includes information presently gathered from traditional meters such as accumulated energy, demand, and time-of-use information. The information gathered must be available to multiple clients. These multiple clients could retrieve the data from a meter, a place within the network, or the back office.

The electric utility can benefit from installation of the method of the invention by reducing Meter Reading forces (as well as other field personnel) and the supporting infrastructure (buildings, vehicles, etc.), streamlining customer service in such areas as billing inquiries, establishing new service connections, improving billing accuracy, providing advanced energy data for forecasting, procurement and settlement, creating additional tariff options, and tracking customer response to demand response programs.

Related to this scenario is gathering newly available data such as net metering, interval energy data, power quality, excessive demand thresholds, results of meter self-test status, and other meter event messages. The actual end users of the data may include the billing system, ISO, ESPs, meter reading agents, load research, forecasting and settlements, outage management systems, building management systems, distribution operators, maintenance, markets, and customer service. Data end users may read data for multiple purposes, including periodic billing, off-cycle billing, outage verification, high bill complaints (or other customer service issues), building automation, bill disaggregating, or local energy management.

Current processes typically require that customer use data flow through one collecting organization within the utility, generally associated with simply retrieving use information. That organization reads meters (manually or remotely) on a schedule that is often determined by a single operational premise or need (e.g. billing). This data is processed and the resulting information posted or archived to specific database locations. Post processing often includes various operations that may aggregate and otherwise modify the original data to fit the primary need of the acquiring organization (e.g. billing or load management). In some cases, specificity of data or other attributes is lost in the post processing action, often driven by system requirements downstream (e.g. billing systems, Customer Information System (CIS) data tables, etc.). Other clients within the utility that need or could utilize the data at the original detail level, are required to post process the use data to convert it to a form that is applicable for their business purpose. Alternatively, they may have to reconstruct original specificity to meet the specific need (e.g. reversing “averaging” operations that may be applied to the data for billing purposes but who's output is not as useful for load management research purposes). Secondary client groups have little or no control over the timing of data acquisition, the format, interval frequency, etc. The primary user group that controls data acquisition most often determines those parameters.

As noted above, a major benefit of the method of the invention is that it supports customer awareness of their instantaneous kWhr electricity pricing and it can support the utilities in the achievement of it's load reduction needs. As we see increased electricity demand on the grid, it may result in energy shortages, therefore triggering the need for utilities to reduce energy consumption in support of grid stability. The method of the invention helps facilitate load reduction at the customer's site by communicating instantaneous kWhr pricing and voluntary load reduction program events to the customer and to various enabling devices at the customer's site. Voluntary load reduction events may be scheduled with a large amount of advanced notice (24 hrs) or near real-time. For the utility to receive the desired customer response, we must provide them timely pricing, event and usage information.

Related to this scenario is the measurement of the response to financial incentives, energy price adjustments and other voluntary demand response programs. The customer responses will be used to determine how and/or if they have responded to a pricing event, if the utility needs to launch other demand response events to achieve the needed demand reduction and help the utility determine how to structure future voluntary load reduction programs, to ensure the utility receives the best customer response.

The method of the invention can initiate automatic load reduction at the customer's site by communicating event and pricing information to customer equipment and the customer equipment will take action based on the customer's predefined setting. The customer will be able to program their load control specifications and refuse utility load reduction requests with a device within their home/business. The customer will also be able to manually curtail load based upon informational messages communicated to them through the method of the invention.

Using the method of the invention, a customer can enroll in an easily managed non-price responsive demand-side grid management program. This program allows the utility to request an automated load reduction at the customer site. The customer can override the request in exchange for a possible penalty charge. For example, there can be at least two levels of advanced warning are envisioned:
Predicted energy shortages (long term—24 hours, and short term—a few hours notice—these two cases do not develop any different requirements for the method of the invention system, but might cause the customer to respond in different ways)
Emergency shortage (for example, a few minutes notice with no possibility of opting out)

Using the method of the invention, the utility can measure (using data from the customer meter) the aggregate load reduction and possibly issue additional reduction requests. The actual load reduction could be fed back into a model used to determine the extent of future load reduction requests. The method of the invention will provide a premise gateway component that may or may not be incorporated into the meter itself. The premise gateway will forward curtailment messages to customer equipment capable of receiving it. This equipment may be a sophisticated Energy Management System, a Programmable Communicating Thermostat, Load control devices directly attached to controllable equipment or a simple display at the customer premise. The premise gateway may or may not be used to return device status and logging information back to the utility on an individual or aggregate basis.

Thus, the method of the invention improves the reliability of the distribution grid during periods when its ability to deliver power to customers is constrained by either supply or available paths. The method of the invention greatly enhances the utilities curtailment capabilities while at the same time reducing the impact of system constraints on customers. This curtailment capability can be used to allow delay of upgrades to power system components. The detailed data collected by the method of the invention regarding customer compliance and actual load reduction allow the utility to better predict curtailment request responses and therefore limit the scope of customer asked to curtail. The ability of the system to allow customers to opt out is critical to enrollment in voluntary programs. At the other end of the spectrum, its ability to ensure curtailment through the service disconnect option provides the certainty required by operators to avoid more draconian measures required to avoid or minimize outage scope or duration. In periods of extreme system duress using curtailment instead of rolling blackouts, allows power to remain available to retail stores, hospitals, traffic lights etc which reduces liability and lost business for commercial and industrial customers. The load limiting capability of the service disconnect switch would likely also allow residential customers to maintain lighting loads enhancing safety and security, but would constrain the customer's ability to utilize unessential loads like pool pumps, electric stoves and HVAC systems. For example:

(1) At the onset of a day where the weather is forecast to be extremely hot or cold or when it is known the possibility exists for a system emergency, the System Modeler runs models to determine where and when times of peak demand will occur. This modeling involves clearly defined parameters such as weather, tracked seasonal load, load availability factors, and customer load served by the transmission and/or distribution system. It is determined that due to maintenance issues or the location of some loads in relation to the infrastructure, the available amount of bulk power and or the transmission capacity is constrained. This results in the probability of a peak demand event that will require reduction of a certain amount of customer load.

(2) Under normal operating conditions, the utility provides from two to twenty four hours notice to the customer that load reduction is required and will occur. In a system emergency only a few minutes notice is provided. Typical emergencies considered would be the result of a generator tripping offline, lightning strikes on critical infrastructure components, or some other event causing the transmission and/or distribution infrastructure to be overloaded or unavailable, The utilities existing system will notify utility personnel and the Method of the invention. The Method of the invention will provide mechanisms to deliver the signal to the customer's equipment. The notification signal can then be used by customer user interface equipment (e.g. a light on a thermostat, the orb, etc.) capable of receiving and processing the signal.

(3) When the peak demand period is about to begin or when the system emergency occurs, the utility control center sends a command via utility's communications infrastructure (internal, leased, or public) that is received by intermediate utility equipment or directly by customer load control equipment. The system operator can target individual regions or specific customers to address the amount of load reduction required and the operational situation of the utility system. If intermediate utility equipment is used (such as a smart meter acting as a communications gateway), the commands are relayed to the load control device. Commands such as “Thermostat Setback,” “Turn Off A/C Unit,” and “Check Transponder Health” are representative of the commands to be sent out. The intermediate equipment and/or load control equipment has auditing capability to determine whether the signals were received and if the load control action was successful. The utility can download data from the smart meter, home gateway and other audit information sources to determine system health and to validate the models used to predict system operation, peak demand, and needed load reduction.

(4) The load control equipment interfaces with thermostats, water heaters, swimming pool pumps, and other load equipment. The customer equipment is located at both residential and commercial locations and was selected for its predicted load patterns and ease of remote control. This use case assumes the applicable tariff will allow customers to choose to override the signal, but they will pay a penalty if they do so.

(5) The utility verifies customer participation via acknowledgment of a successful “Turn Off” command. After each instance of load reduction, the utility conducts an assessment of how many MW of load was reduced and uses this information, along with a review of the command logs and receipt of successful “Turn On” and Turn Off” commands to refine the model used to ascertain when the load control programs need to be activated, how it needs to be implemented across the service territory, and operating condition of the communications and control equipment.

The method of the invention provides real time monitoring of the status of customer meters and accounts. Such monitoring can be performed on a frequency and schedule that is fully configurable for the specific situation and location. For example, the method of the invention allows the utility to conduct detailed diagnostic studies for a specific customer meter or group of meters, setting the desired frequency of the interval data being recorded and reported without compromising other downstream data clients or systems (e.g. switch interval frequency from hourly increments to 5 minute intervals during on-peak periods, etc. for a power quality investigation while allowing billing-related clients to pole the same group of meters and retrieve 15 minute interval data for billing purposes). Such detailed forensic activities are not possible with current meter systems.

The method of the invention also provides the utility's CIS application and architecture with more detailed account information and integrate account diagnostics results to support self resolution and answering of questions based on the customers' ability to perform usage analytics based on historical consumption patterns. Existing customer service processes can be overhauled and transformed to integrate with the method of the invention.

### Use of Data by Third Parties

The method of the invention allows for and facilitates authorized access by third parties of customer energy use data and other information through connection at the advanced utility meter. Current processes typically require that authorized third parties' work through the utility to obtain information, increasing process loading at the utility and causing conflict with third parties and customers, if requests are delayed or mishandled. The method of the invention creates an information node at the meter point that can be accessed by multiple client groups and will provide acquisition of available data and information configured to best meet the need of the specific client acquiring the data.

Thus, the method of the invention provides enhanced ability to support third party energy service providers through secure yet flexible 2 way communications to query the meter, change user-configurable factors (e.g. energy rates for Direct Access (DA) customers) as applicable and report third party activities at the meter level for record and control purposes. With enhanced security and monitoring of third party access, a utility using the method of the invention is able to authorize third parties, via two-way communication channels, to practice “self service” access to customer meters directly in support of their service offerings and eliminate the need for the utility to be directly in the process flow. Also, the method of the invention provides the utility with supervisory and enabling functionality for third party access and needs and can reduce internal processing and management requirements significantly.

It is the open architecture of the method of the invention which allows other utilities to deploy this type of meter and the electrical utility will host and enable meter reading on behalf of such other utilities. Thus, the method of the invention provides the ability to back haul data collected from non-utility owned devices such as water and natural gas meters. Collection and processing this data can provide nominal incremental revenue streams for the utility.

For example, a third party vendor may want to identify what customer equipment (e.g. air conditioning, pool pumps, compressors, etc) is running and how much power each piece of equipment is drawing during a particular time of day. The vendor may also want to control or program specific equipment (e.g. turn on/off, adjust thermostat). The third party vendor can then make an on-demand status and/or control request of the customer equipment. The monitoring or status request is received by the CCS, the requester and destination is authenticated and then the request is transmitted to the specific customer site. The customer equipment receives the request and provides a response back to the CCS and the CCS transmits the information back to the third party. If the on-demand request is a control request, the customer equipment will adjust operations as requested and provide an acknowledgment of receipt and processing through the CCS back to the third party.

The third-party monitoring and control capabilities of the method of the invention provide customers with increased options for programs and services that might not normally be provided by the utility. These proposed services will enable customers to more easily participate in utility and non-utility demand reduction programs, by allowing third parties to help them monitor and control their equipment.

For example, a non-electric utility operating in the electric utility's service territory may desire to have the method of the invention provide meter reads on its behalf. This other utility may not intend to acquire and install new meters in order to achieve this capability, however their existing meters (or attached devices) must be compatible with the electric utility method of the invention. The non-electric utility can enter into an agreement with the electric utility for contracted meter reading. Thereafter, on a regular schedule, the method of the invention collects the other utility's meter read information and transmits this data to the requesting utility. Going beyond basic meter reading, the non-electric utility may desire to extend the electric utility contracts such that they are able to utilize additional advanced capabilities that may be made possible by the method of the invention. Examples of such functionality might include on-demand meter reads, interval meter reads, remote meter on/off switching, and other monitoring and control functions related to the meter or other devices at the customer premise.

### Prevention of Energy Theft

Energy theft is a serious problem. Meter tampering and current diversion account for significant lost revenue. As energy prices increase, cases of energy theft are likely to rise also; resulting in consumer rate increases to offset the losses. Tampering and energy theft also pose serious public safety concerns. A tampered meter can cause burns, severe injury or even death to thieves, bystanders and utility personnel. Adding to this problem is the increased availability of information on energy theft techniques. Publications, and more often today the Internet, provide easily obtainable information on methods of stealing power. Energy loss due to current diversion and meter tampering exists regardless of social or economic group. Theft can range from periodic meter interruptions to ongoing diversion. Even larger losses can be attributed to illegal taps into the power supply. Energy theft, such as meter tampering, occurs daily and can go undetected for months, even years. Tampering can be as simple as inverting the meter to more sophisticated methods such as installing jumpers or other instruments to disrupt accuracy. Wiring in photocells or resistors to alter meter precision is a subtle and difficult to detect manner of meter tampering. Enterprising thieves have even gone as far as installing timers or switches to control meter validation. The two main categories of energy theft are physically tampering with the meter (removing and reinstalling and/or breaching of the physical meter case) and bypassing the meter.

A more benign form of meter tampering is the temporary removal of a meter by a customer and/or contractor while electrical work is being performed at the customer's premise. Once the work has been completed the meter is replaced and service fully restored. In most cases these temporary situations go unnoticed with the current state of residential metering, and for the most part little or no harm is done. However, in some cases when the meter is reinstalled it is not installed correctly or is damaged causing inaccurate measurements to be recorded. This can result in inaccurate bills being issued as well as increased costs to the utility to replace/repair their meters once the fault has been isolated.

The typical procedures in the prior art are the monitoring, detecting and resolving of meter tampering questions based mainly on manual instruction processes. Also, energy theft via bypass and meter tampering is a significant problem and the typical procedures in place to monitor, detect and resolve meter tampering questions are based mainly on manual inspection processes. The highest volume categories of energy theft currently include jumpers/bypass situations, tampered meter situations, and foreign meter installations. Most jumper/bypass thefts occur ahead of the meter, before the energy is measured by the device. Existing automatic meter reading (AMR) systems possess the ability to identify when a meter is disconnected from the socket and these systems will send the utility a “flag” identifying the “disconnection event”. These systems do not possess the ability, however, to identify energy consumption that is occurring inside the home by bypassing the meters registration capabilities. Moreover, AMR deployments generally eliminate the normal visual inspection that routinely occurs during the manual meter reading processes. The visual inspection currently serves as the primary method of surveillance for the distribution infrastructure and is the main process for identification of improper or illegal electrical connections and other meter bypass conditions.

In the method of the invention, the advanced utility meter can be provided with tamper detection capability. An advanced utility meter with tamper detection enables the utility to sense a change in consumption that could mean a damaged/malfunctioning meter. The ability to identify and resolve these situations in a timely manner would prevent an impact to bill quality from the damaged meter. A definite audit trail showing precisely when the tampering occurred and showing that the meter was operating correctly prior to the event and began malfunctioning after the meter was reinstalled would provide evidence sufficient to possibly compelled the customer and/or contractor to pay for the replacement/repair of the meter, which is after all the property of the utility.

Furthermore, global positioning satellite (“GPS”) technology components can be embedded in the advanced utility metering hardware to provide the utility with information regarding the explicit location of the meter. GPS location data can be used to validate and ensure that the customer account is using the geographically correct baseline region, that the appropriate calculations are being performed for franchise fee payments, that the appropriate assessment, collection and ultimate remittance of Utility User Taxes is carried out and that the customer account is assigned to and taking advantage of the appropriate utility tariffs and that performance under those tariffs is tracked and understood.

Still further, the method of the invention can be used to monitor energy use at a meter location and determine if it is appropriate given the status of the account. The method of the invention can also be used to automatically notify the utility when use patterns and volume are outside that which is established as normally acceptable ranges for the status of the account. The method of the invention further allows the utility to remotely, routinely and efficiently identify energy consumption occurring on the customers' side of the meter, in situations where the meter status is in “disconnect” or “curtailed service” mode.

Thus, the method of the invention enables multiple utility (or authorized non-utility) operating groups to access selected and specific customer meters on an as-needed basis, independently of other applications or service methodologies and within the time frame and on the frequency needed by the client's specific business application and purpose.

### Customer Interface

The method of the invention further provides for two-way communication with each of its customers.

Having a two-way communication link with each of its customers provides the utility with the ability to notice each customer regarding rate structures and usages and receive back from each customer communications.

The two-way communication system also now provides the first time ability to interact with the customer and exchange information to allow both the customer and utility operate more efficiently.

### The Utility's Ability to React & Take Action

In typical prior art systems, the utility is forced to take actions based on estimates of energy usage and patterns of usage. In the case of curtailment, a significant unknown variable is the size of the geographic area that needs to be notified in order to attain the reduction required to alleviate an emergency situation.

The method of the invention provides accurate information on which loads are operating can be fed to the utility that will allow it to take preliminary action to prevent the need for a curtailment and then if needed, trigger a curtailment program more efficiently and in a smaller area to for the least amount of impact on customers.

The method of the invention allows the utility to know which appliances are “on” in advance of an emergency curtailment rather than possessing only aggregate load or usage data at the meter. This capability allows the utility load management and demand response group to add another level of real-time data to their decision process regarding when and how to activate a specific curtailment action as well as improve the speed in which grid reliability can be maintained.

The method of the invention also provides the utility with the capability of communicating and interfacing with select load consuming devices throughout the customer's area. These devices include load switches, smart thermostats, intelligent circuit breakers, and appliance control modules. This enables the utility to selectively interact with these devices and surgically reduce load as required in order to avoid potential emergencies.

Not only do curtailment programs enable the utility to target specific appliances—easing the customer burden and further encouraging participating and focusing incentive programs, but the real-time access to and accuracy of the actual customer use data enables the utility to ensure the curtailment goal is being achieved.

For curtailment participants, incentives are typically provided to customer in order to encourage customers to participate in such programs. Accurately paying customers for participation and their level of participation is extremely valuable in keeping the costs of such incentives low.

In the past, payments are made with estimates of load reduction and true-ups at the end of a billing cycle. The exact amount of reduction is not known until after the event or action occurs. Participating customers are then rewarded for participation and sometimes penalized for non-participation.

With the method of the invention, the utility will be able to accurately measure the exact amount of reduction that occurred at a facility and thus will be able to more accurately reward a customer for the demand reduction achieved and more closely align with the utilities derived benefit.

Also, by interfacing the method of the invention with other metering devices, customer data is immediately provided to other areas where actions can be taken to react to issues the method of the invention is sensing or from data the system is receiving. The ability to react to this data and reductions in response times, or by automatically responding to potential problems will mitigate potential problems from cascading into larger issues.

### Notification of End Use Customers

The method's two-way communication provides the ability to inform customers of pending situations or actions which the utility will be taking. In the case where the utility sees a potential load issue that could lead to the need for a curtailment, notification can be made to a customer prior to an emergency situation. This will enable a customer to voluntarily turn off appliances or cut back on miscellaneous energy use to help avoid a potential more serious problem from occurring. The real-time monitoring of reductions in load enables the utility to make a final call on whether curtailment will take place.

The customer notification system also has the ability to convey critical pricing information associated with existing and anticipated new tariff offerings designed to reward customer response behavior. The method of the invention is used to notify customers when they are approaching or are in critical pricing periods, giving them the opportunity to react accordingly.

Using the method of the invention, each customer can access his or her most recent usage and pricing data via their meter or display device to determine how much energy they are using and the associated costs at their site. Then the customer may reduce their usage by raising their A/C thermostat, which cycles off their cooling mode. The customer can view the results of the change in his or her per energy consumption, displayed in energy usage and cost data on their meter or in home/business display device (if equipped and it meets the utility requirements).

The customer may also want to view his or her historical energy usage data from the previous day. The customer logs onto a utility website, selects an account and requests the usage period for the previous day. The usage data is displayed on the website for the customer to view. The customer then requests cost data to display for the same period. The cost information displays on the website.

A major benefit of the method of the invention is that it supports customer awareness of their instantaneous kWhr electricity pricing and it can support the utilities in the achievement of it's load reduction needs. As we see increased electricity demand on the grid, it may result in energy shortages, therefore triggering the need for utilities to reduce energy consumption in support of grid stability. The advanced utility meter will help facilitate load reduction at the customer's site by communicating instantaneous kWhr pricing and voluntary load reduction program events to the customer and to various enabling devices at the customer's site. Voluntary load reduction events may be scheduled with a large amount of advanced notice (24 hrs) or near real-time. For the utility to receive the desired customer response, we must provide them timely pricing, event and usage information.

Related to this scenario is the measurement of the response to financial incentives, energy price adjustments and other voluntary demand response programs. Customer responses can be used to determine how and/or if they have responded to a pricing event, if the utility needs to launch other demand response events to achieve the needed demand reduction and help the utility determine how to structure future voluntary load reduction programs, to ensure the utility receives the best customer response. This scenario includes the actual mechanism to distribute price signals and voluntary load reduction events to customers (direct electronic delivery to the customer meter, display device within the home/business, automated telephone calls, e-mail, pager, commercial broadcast radio, newspapers, etc.). It includes the mechanism by which the advanced utility meter will display current pricing and voluntary load reduction event information within the customer's home/business. The advanced utility meter will initiate automatic load reduction at the customer's site by communicating event and pricing information to customer equipment and the customer equipment will take action based on the customer's predefined setting. The customer will be able to program their load control specifications and refuse utility load reduction requests with a device within their home/business. The customer will also be able to manually curtail load based upon informational messages communicated to them through the advanced utility meter.

Thus, vital information such as energy efficiency tips, new rebate programs, or changes to billing and service are usually provided to customers through mail, advertising, or bill inserts. Studies show that customer often ignore such information and fail to capture benefits or participate in programs that can benefit them. However, text messaging through the two-way communications aspect of the invention can replace previously used modes and provide direct communication with customers to ensure that information is received.

Customer Interaction with the Utility

The method of the invention sets up a portal of communication between the utility and the customer in order to allow the customer to understand current information and then have the ability to react to that information. Real-time and historical usage data is provided to customers that allows customers to track and monitor their energy consumption.

Also, the method of the invention also has the ability to provide real-time monitoring of equipment or appliances and provide notification to various outside agencies if some appliances are triggered.

The method of the invention provides for quicker bill inquiry resolution and even facilitates self-resolution based on the customers' ability to perform usage analytics based on historical consumption patterns.

The method of the invention also can provide pre-pay alternatives to the customer. This new portal provides customers with convenient payment options that allows the utility to further reduce customer costs by eliminating manual meter data gathering.

Still further, the method of the invention results in reductions in costs for other services. For example, service costs, such as reconnection, can be reduced because the utility knows which customer is consuming energy and can eliminate any soft costs affiliated with customer transition into and out of new location.

### Energy Delivery

In areas of energy delivery, the method of the invention provides many improvements to be made by providing two-way communication between all energy delivery devices that are utilized for the grid system. The system gives the utility the ability to utilize the information to (1) efficiently manage the grid, (2) maintain reliability of the grid, and (3) characterize and inventory distributed energy resource (DER) assets. These improvements result in improved curtailment programs, transmission level stability, identification of DER assets on the grid, and restoration of systems following outages.

For energy delivery, a utility using the method of the invention is given the ability to communicate with proactive systems that contribute to delivering energy to the grid. The method of the invention allows the utility to coordinate, dispatch, and monitor all activity on the grid where in the past, real-time information was not available. This information allows the utility to maximize the use of the all assets that are contributing or have the potential to contribute to grid reliability—or track assets at customer sites that have the potential to reduce grid reliability.

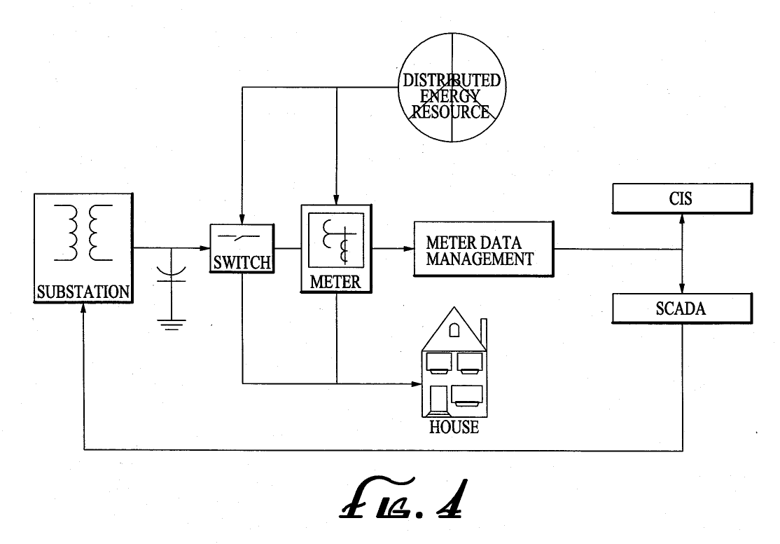

FIG. 4 illustrates a typical circuit design useable in the method of the invention. The components that are uniquely tied together are listed as the meter and meter data management system, the distributed energy resource, the Supervisory Control and Data Acquisition (SCADA) system and the Customer Information System (CIS).

Distributed energy resources are typically listed as fuel cells, solar, small wind, or micro-combined heat and power systems for residences. For small C&I and large industrial customers, typical distributed energy resources also include traditional on-site generation, renewable generation, and clean distributed energy resources. Distributed energy resources also include demand response and curtailment systems that are integrated into the grid and can be used for grid management purposes as well as an economically dispatched energy supply option.

The process improvements provided by the method of the invention are derived from two basic areas based on two-way communication and detailed data from systems and assets on the grid: monitor and manage the grid and monitor and manage distributed energy resources.

### Identify and Rectify Outages

The method of the invention offers excellent opportunities for enhancing a utility's ability to identify and rectify outages. Currently, utilities are constrained in their response to outages by the sensors, or information available to them. SCADA systems typically extend only to the substation. Remote Fault Indicators (RFIs) provide insight further into the network, but are limited in number. The method of the invention is the only system that extends (by definition) to the extreme ends of the utility network. The method of the invention systems can sense every line segment and transformer on the system. This capability can be used to verify not only pinpoint outages but power restoration as well, enabling utilities to proactively identify customers who have not yet been restored. Outages reported by other systems (SCADA, DCMS or even customers) can be explored to determine the extent of the outage. This capability can reduce labor and truck roll costs by better identifying the cause of outages and sending the proper people and equipment. Further truck rolls can be eliminated by verifying customer reported outages are not customer equipment issues.

DOC (Distribution Operations Center) dispatcher can use individual customer outage information to reduce the duration of outages. The utility utilizes the messaging from the customer meters or status of customer meters from the method of the invention to determine the extent of the outage. Using this data, the utility can locate the most probable failure point and re-configure distribution switches to minimize the impact of the fault (possibly by minimizing the number of critical customers affected by the fault). The fault location can also be used to dispatch repair crews to the trouble areas to allow restoration of power to the remainder of the customers. Upon repair, the switches are re-configured back to their original positions.

Key Benefits include but are not limited to:
Improved customer satisfaction by using meters to help verify an outage.
Detection of outages at distribution transformers or other common points of failure reduces the response time and potentially the cost of restoration
Timely detection of outages allows for potentially improving the distribution network reliability statistics
Detection and recording of outages allows for validation of liability claims (The Utility would know which claims attributed to outages actually correlate to an outage and which ones do not)

The distribution operator can use individual customer outage information provided by the method of the invention and Outage Management System (OMS) to detect an outage, locate the cause of the outage, isolate the faulted portions of the distribution network and develop the optimal solution for the restoration of service.

In order to determine that an outage is occurring and record the duration of an outage in the distribution network, the OMS is sent outage reports provided by the method of the invention.

The OMS can determine the affected section of the distribution network and the probable location of the fault causing the outage from information sent to it by the method of the invention and customer phone calls. For this it continuously monitors—customer information provided over the phone to a call center—outage detectors on distribution feeders—the method of the invention neighborhood aggregators—crew information on the repair status—SCADA inputs, such as feeder measurements at the substations and on the various transformers in the distribution network, lockouts, protection trips, fault indications/location, etc.—inputs from outage/fault-predicting devices

When an outage occurs, customers will contact the call center to inform the utility of the outage and to obtain information from the utility on the cause of the outage, the size of the affected area and the possible duration of the outage.

The advanced utility meter can report an outage and indicate if the supply side of the meter is affected. This provides information to the call center, so that, when the customer calls to report the outage, the customer can be informed whether the problem is at his or her own premises.

Area outages can affect many customers and affect the ability of the advanced utility meter to communicate with the system. Therefore the outage detection in this case utilizes so called “last-gasp” messaging from the customer meters or other information from the system to determine the extent of the outage. The System indicates contact with advanced utility meters in an area has been lost and allows the Outage Management System to deduce the outage area and equipment involved.

The distribution operator can then dispatch repair crews to isolate the outage and/or restore service and/or repair the damage. For this purpose he or she issues a work order to the repair crew. This work order includes the outage location and information regarding the affected customers from the Outage Management System. The crews are dispatched and periodically report the status of the repair to the Outage Management System.

After a power outage, the system returns to its normal operating state. The advanced utility meter retains data and continues to measure a customer's power usage during communications failures. After a communications failure is repaired the system transmits its stored data and resumes a normal communication schedule. If present, data aggregators may also retain some portion of data.

Equipment failures should be detectable by system components that are aware of the absence of expected data. Failed equipment has the ability to be replaced and restored to the same state as prior to the failure. Outages will be logged but will have no other permanent effects upon the system.

For a wide-area outage, it is important not to overwhelm the communication system. The method of the invention can communicate planned outages to all involved actors. The method of the invention then attempts to classify the failure cause to optimize the recovery response.

The method of the invention can have the ability to detect all communication failures. Upon failure, the advanced utility meter logs the failure event and awaits restoration of the communications. The advanced utility meter recovers any information which would have been sent to it in the absence of the error.

The method of the invention, upon detecting a communication failure from an advanced utility meter, can log the failure and attempt reconnection. If the restoration is not successful, the system will identify the failed device and initiate a repair from an appropriate department within the utility. Upon replacement of the failed component, the method of the invention can ensure system integrity and restore any required configuration data. If the restoration is successful, the method of the invention can verify that the correct meter is operational and log the reconnection.

The ability of the method of the invention to determine whether a failure is associated with an already issued trouble report, or a planned or unplanned outage avoids the possibility of assigning two crews to the same problem. Additionally, the ability to recognize meters with only a single communications path available (or no path available) will permit prioritization of the workload to ensure that the network is always able to reach the most meters possible. By better understanding the critical/non-critical nature of various failed components could also allow for better scheduling of field service personnel and potentially reduce overtime costs. Lastly, the ability of the method of the invention to build a history of component failures will allow for better decisions in augmenting the communications network focusing on areas of greatest stability risk.

### Monitor and Manage the Grid

The method of the invention allows the utility to efficiently curtail energy usage. For energy delivery, curtailment expands beyond notification and tracking of load shedding but is an integral function in maintaining the grid system. Curtailment is a tool which the utility uses to maintain grid reliability.

In current systems for small C&I and large industrial end-users, when load is required to be shed through demand reduction programs or demand side management programs, a notification system is required. This process involves notifying the end-use customer of a request to curtail, receiving acknowledgment by the end-use customer that load will be curtailed, and then having the end-use customer physically shed the load. Such a process not only contains manual actions that add time to the process, but lack the physical assurance utilities require to confirm that the predicted amount of load was shed.

Utilizing the method of the invention's dynamic interfaces at end-user, the utility can create a process that provides the utility with the ability to have instantaneous control over loads and the ability to confirm the amount of load shed. This process improvement significantly improves the utility's reaction times and decisions on proper actions required to maintain grid efficiency, avoid potential blackouts, and mitigate transmission level instability.

For residential customers, similar process improvements are provided in the method of the invention to simultaneously notify and enact curtailment programs for residential appliances. In past processes, home appliances were utilized for load reduction programs. However, without physical assurance of how much load was actually shed at homes or accurate data itemizing the amount of load that is shed during program activation, uncertainty still plays too significant a role in the process.

The method of the invention allows the utility to read and sum the reductions seen on the grid and take proper courses of actions on circuits to prevent emergencies from occurring.

The curtailment capability of the method of the invention has additional features to allow the utility to remotely curtail energy usage at the meter panel. Current systems provide no course of action if expected load shedding does not occur or if there are breakdowns in the notification process.

The method of the invention gives the utility the ability to remotely change the maximum energy consumption at any metered premise in situations where immediate actions are required to avoid potential emergency situations.

The method of the invention also increases reaction times and prevents transmission level events from cascading down a system. If a transmission level event causes a voltage collapse, that voltage collapse tends to cascade down the system. Changes in voltage/frequency might also increase currents in the system. Previous processes had no ability to quickly detect and initiate actions, and the system at issue would continue to decay and cause the problem to increase in magnitude. In such cases, however, the method of the invention can automatically initiate activation of a switch to interrupt power flows and isolate the detected problem.

The inability to monitor real time loads and delays in obtaining information on the load demands also has a significant impact in the restoration process. In cases where demand is intentionally or unintentionally forced off the gird, restoration can take a significant amount of time to complete.

Past processes had to either account or estimate the load that was off-line and what load demands would be immediately brought on line after grid power is restored. The method of the invention can identify resources, resource availability, and ramp-up conditions that ensure proper and timely restoration and prevent load surges during restoration from creating additional problems for the grid.

In past systems, a power quality event of a single device could result in cascading effects that can result in single or multiple service interruptions. Examples of such cases are seen in air-conditioning compressor stalling events that lead to catastrophic power interruptions.

The method of the invention enables the utility to detect increases in voltage and the corresponding increases in current. The method of the invention uses its internal measuring and reporting capability and initiates actions such as opening contacts to isolate the problem at the specific site and prevent any cascading problems from occurring on other circuits.

Also, the method of the invention enables the utility to detect voltage drops at the metered site. In the past, such drops would require manual reactions or a manual response to the problems the sudden voltage drop caused on the system.

With the method of the invention, a communication signal is automatically sent to activate or engage a power conditioning device to activate the distribution management infrastructure—capacitor bank, controllers, auto-reclosures or circuit switching devices. By automating the process, reaction time is significantly increased to enable prevention of additional grid problems.

Optimizing the network involves issues with feeder loading, voltage profile, efficiency, reliability and quality. The utility uses feedback from the method of the invention to both improve customer power quality and reduce distribution costs to the utility. The method of the invention outputs can include average voltage at customer site, voltage variations seen by the customer, power consumption by time interval, harmonics (voltage and/or current), power production by customer-supplied distributed generation, and customer power factor. The utility can use this data for warning letters to customers (if they are adversely impacting the network), feeder capacitor bank switching, transformer voltage tap switching, for input to load forecasting models (both short- and long-term), for feeder harmonic filter controllers, and for feeder switching decisions. The method of the invention can also be used to provide connectivity to distribution system devices (e.g. IEDs/RTUs, sensors, fault indicators, etc.) in addition to, or instead of the measurement information from the customer meter as a sub-scenario.

The nature and low cost of the method of the invention provide many opportunities for automation within the distribution grid that are not economically feasible with bespoke systems. The advanced utility meters in the method of the invention can be configured to collect information at a detail level and at a scale not currently feasible. Signature analysis done on collected Power Quality Data could help detect grid problems before they become acute and result in outages or equipment failure.

By moving intelligence out of the grid, using the method of the invention, and by employing the ability of the method of the invention to interact with devices, the network can proactively optimize itself. An example of this is the Capacitor Bank control. Existing systems are triggered by the voltage at the CBC and are set by experience to activate based on a best guess of endpoint voltage from surveys and history. The reality is that the level of response is highly dependent on the characteristics of the load and the distance of the load from the feeder origination. Feeder reconfiguration, variances of load source (e.g. time of day on a feeder that services a mixed residential and light industrial customer base) and other factors can make these preset response values less than optimal. Using the method of the invention, CBC's can either query a subset of bellwether meters based on trigger voltages at the bank, or they can be set up to receive voltage levels from those meter periodically during the day. The CBC can base it decisions on the endpoint voltage. This offers the benefit of enhanced voltage control resulting in improved circuit efficiency and loss reduction.

By pushing the intelligence even further out into the network, the system of the invention is capable of being even more responsive. Remote Circuit switches can be used to interact with Remote Fault Indicators to reconfigure the feeder in response to a non transient fault. This enhanced capability brings with it the need to communicate with elements of the system when their associated grid components may be de-energized, but without the ongoing communications throughout the fault, the complexities of sorting out recloser, sectionalizer and fuse timings becomes considerably more complex. With communications between energized and non energized elements the system could try several solutions before giving up, thereby reducing the number of customers affected and reducing the labor required to restore service.

On a broader scale, there are a number of places in the distribution system where monitoring information will allow for condition based maintenance (e.g. transformers, switches, capacitors). Only maintaining equipment when it is needed will result in lower capital expenditures for equipment replacement and will improve system reliability by avoiding unexpected failures. Today, the cost of communications keeps this from happening to any large extent. Implementation of the method of the invention can put in place a low-cost path for obtaining this information.

When measuring voltage and current at a customer site these base measurements can be used to calculate many relevant power system data values that can serve as input to existing and new power system applications.

### Monitoring and Management of DER Assets

As noted above, for billing and customer service, the advanced utility meter is used to identify energy theft ahead of the meter. Today, the highest volume categories of energy theft include jumper/bypass situations, tampered meter situations, and foreign meter installations. Most jumper/bypass situations occur ahead of the meter—before the energy is actually measured by the device.

Currently, many automatic meter reading systems possess the ability to identify when a meter is disconnected from the socket and can send the utility a “flag” identifying the disconnection event. However, these systems do not possess the ability to identify energy consumption that is occurring inside the home by bypassing the meters registration capabilities.

The new capability provided by the method of the invention allows a utility to remotely, routinely and efficiently identify energy consumption occurring on the customers' side of the meter in situations where the meter is thought to have been disconnected from service. This is an important feature because implementation of any remotely read meter program eliminates the normal visual inspection that routinely occurred during the manual meter reading process which served as the primary surveillance of the distribution infrastructure and facilitated the identification of improper or illegal electrical connections and other meter bypass conditions.

The method of the invention also allows the utility to identify distributed generation conditions and provide improvements in several ways. First, regarding a power source consumed locally or capable of providing grid generation, in past applications, meters have not been able to provide information on generation being produced locally, hence leaving the utility open to unplanned and unpredictable potential swings in demand at any given time. The method of the invention enables the grid operators to obtain valuable information regarding specific source data (identification/notification of DG), volume of distributed generation supporting demand at any given time.

For many years distributed generation (DG) has had a relatively small impact on utility operations, Traditionally, distributed generation has served as a primary or emergency back-up energy source for business applications that place a premium on reliability and power quality or it has resulted from manufacturing processes that are able to produce electricity as a by product. Additionally, solar, geothermal and wind power have offered consumers the opportunity to reduce their utility bill and meet some or all of their power requirements with environmentally friendly alternatives, spurred by the volatility in the energy marketplace, and abetted by new technologies, a number of manufacturers in recent years have brought or are bringing to market small-scale generators and other resources that can economically wholly or partially provide the electricity requirements of a single home, business or even a neighborhood. The availability of these systems coupled with increasing concern about the nation's energy infrastructure is encouraging legislation that will facilitate even more penetration of distributed generation in utility grids.

Utilities stand to benefit from distributed generation as well. Distributed generation can reduce the peak loading on the grid. It can also help support line voltage at the end of long distribution circuits. The utility could also install generation to supplement or defer grid upgrades where space, economics, or other constraints prevent the expansion of substations or the building of new distribution lines. An example of this would be installing distributed generation to improve service near isolated loads currently supplied by a long transmission line.

That said, under current technological and fuel cost assumptions the number of applications where DG can substitute for distribution is likely to be limited.

The method of the invention system with its extensive footprint and advanced metrology capabilities can provide mechanisms that enable distributed generation to be deployed with greater safety and enhanced overall system reliability. The method of the invention can enhance installation coordination, metering and address safety issues.

As noted above, the method of the invention can also help control real and reactive power requirements on the distribution system. For example, a customer signs up to allow utility control of DG for regulation of real and reactive power. The customer must abide to utility request or face contractual (typically cost) penalties. The utility monitors in real-time actions taken by the customers. The utility signals may consist of power factor modifications and remote generation disconnection requests. Utilities may also have the capability of monitoring individual customer actions such as verification that requested load reduction actually takes place. The utility benefits by reduced power requirements from the grid during high-cost periods.

Key benefits a utility can realize from a DG-ready system of the invention include:
Increased participation on load management
Elimination of requirement for two independent sets of meters
Provides a communication path from the utility to the load management devices (load management in the broad sense to include on-site generation)
Reduced installation costs for enabling customer-provided DG (this may increase DG participation rates)
Ability to dispatch and monitor DG

There are several scenarios that the method of the invention will be advantageous regarding DG:
A customer enrolls in a DG program. The customer's meter is then programmed remotely to allow proper crediting of the account for generation received by the utility. Other sub-scenarios describe what happens if the customer starts generation before the meter can be properly programmed.
Customer notification (and possible disconnection) should occur if DG is enabled without a valid utility contract.
Utilities can use a customer's DG unit to help control real or reactive power imbalance on a distribution circuit. The trigger for these signals to customer DG units could be either voluntary (price-driven) or mandatory (contractually-driven). The design of these triggers is out-of-scope for this use case. Utility monitors energy flow at metering point to infer customer response. The utility may also use generator metering and monitoring to accurately determine actual customer response.
Customer's DG Provides Customer with Power during Utility Outage. This scenario has no effect on the utility so was not covered in this use case. Utility interconnection requirements ensure that protective relaying will prevent back-feed during outages. The utility, for research purposes, may want to know the quantity of customer load maintained by the DG during an outage (in this case, it can simply ask the customer to report the size of the DG).
Customer DG is Used to Provide Power for a Small Island. Again, this scenario does not involve the utility if it takes place behind the customer meter. If it were to involve the utility's distribution system, this would be very difficult for the utility to accomplish. The utility would need to supply enough automated disconnect switches to ensure that every possible island would be small enough to be served by any subset of customer DG units. In addition, the utility would need to communicate with customer generation and loads during power outages (not always possible) to maintain a balance of load and generation. The customer DG units would also need stand-alone capability (ability to regulate frequency and voltage to feed both dead lines and isolated loads) as well as start-up coordination among other customer's DG units (to allow load sharing and voltage control). Since many customer DG units are dependent on the utility power for commutation, the loss of the single strong frequency signal provided by the utility generator would also enhance the likely hood the system could quickly become unstable. Finally, while a DG operator could be contractually bound to operate it as dictated by the needs of the grid, contracts, with their inherent complexity, ambiguity, multiple interpretations, and tendency to resolve disputes, would not allow the utility to fulfill its obligation to provide safe and reliable operation of the distribution system.

Given the significant safety, security, access and other environmental concerns that come with the use of customer sites for utility generation, it becomes apparent that in the near term a more viable approach for distributed utility generation is utilization of the utilities own dispersed facilities such as substations, where environmental concerns have already been addressed and secure, high speed, highly reliable communications already exist. While the position of the distributed generation relative to the start or end of a feeder does have an impact on the infrastructure, there is no obvious major disadvantage to placing the generation at the head end of the feeder and some clear disadvantages to placing it elsewhere—beyond the issues already discussed. Probably the most significant of these is the fact that the coordination and configuration of the reclosers, remote circuit switches and fuses is already complex enough. The placement of generation units with sufficient capacity to economically serve more than a single customer with the required logistical support would require significant modifications to protection equipment to insure safe and reliable operation of the system as a whole. Placing the generation at the head of the feeder would allow the protection equipment to continue to operate normally without major changes.

Second, regarding potential resources that can be tapped during planned or emergency situations, in areas where load reduction can provide congestion relief, knowing what resources and available and reliable are essential in order to take proper actions to avoid ramifications such as rolling blackouts. Data that enables the utility to track the distributed assets on the system and provide a physical assurance for the availability of the assets on the system gives the utility the ability to improve their reactions to planned or emergency situations by utilizing accurate and real time data rather than estimates as to how many resources could be available for use.

Finally, regarding identifying unreported distributed generation devices, crew safety is enhanced by the new ability to identify distributed generation when a circuit, feed, or customer is thought to have been disconnected, but in fact may be utilizing a generation source that is presenting a back-feed condition. If unknown and undiscovered by responding crews, a greater risk of potential injury exists during restoration activities. The method of the invention eliminates this potential risk.

Furthermore, the method of the invention tracks and records the individual inflows and outflows of distributed energy resources that provide energy to the customer and the grid, thus improving grid operation and performance. The utility is provided with the ability to utilize the data to measure the total generating capacity of any given site, the amount of energy produced and energy produced during peak operating periods.

This information is vital for renewable applications that are considered to be intermittent in nature, such as small wind and solar PV applications. Today, in a residential application, a mechanical meter is installed at a customer's site for DER applications such as solar panel arrays, small windmill, etc. Typically meters currently located at a customer's site provide only net energy usage information, which is the net balance of energy either consumed or delivered by a “generation” site. Such mechanical meters cannot record or report the individual amount of energy generated by that system, separately from the amount of energy consumed at that site. The meter can only record and report the resulting sum balance.

### Energy Procurement

Utilities currently rely on historical data, statistical sampling and load profiling methods to estimate how end use customers will likely respond under various scenarios (e.g. time of year/month/day, weather conditions, etc.). These estimates are used as proxies for developing short-term and real time load forecasts and the planning and acquisition of power supplies adequate to meet customer energy needs in day-ahead and real time. The utility power procurement planners' objective is to acquire only the appropriate supply resources available to meet expected need and thus minimize cost. If in real time energy consumption differs significantly from that which is expected, the utility is forced to purchase or sell energy on the spot market at prices that are typically extremely costly to the utility.

The utility energy procurement operators continuously economically optimize supply resources to match forecast loads. Timely inventory and characterization of supply resources, including controlled generation, market purchases and DER assets allow operators to confidently optimize resources to minimize cost and maintain reliability.

Lack of timely end use data currently impacts the utility's ability to modify short term and real time load forecasts to reflect regional or sub-regional load demands for procurement purposes as well as identifying and estimating unaccounted for energy and settlement costs associated with ISO and wholesale market transactions. Actual use data is typically not available for 30-45 days thus opportunities to better balance and manage settlement processes and costs are lost.

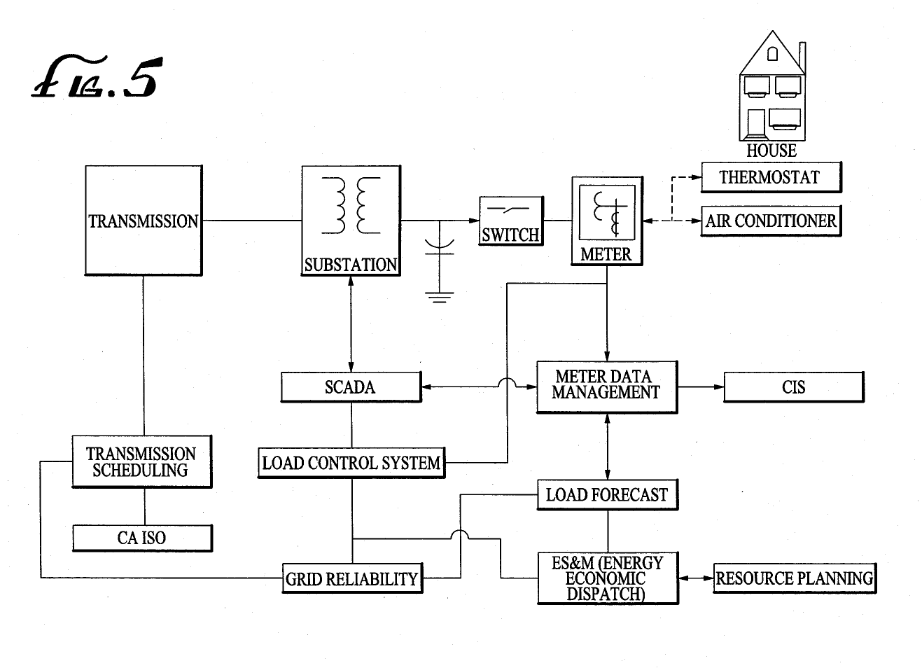

FIG. 5 illustrates a circuit design and distribution interconnection meters of the transmission circuit meters and advanced utility meters at an end use location employing the method of the invention. In many cases, the end use advanced utility meter may act as a gateway to systems beyond the advanced utility meter that enable two-way communication and control for assessing capability, status and response of consumptive equipment or DER assests. Behind the meter equipment and systems, include the central air-conditioning system, pool pumps, thermostats, refrigerators, washing machines, gas and water meters and spare appliances for residential customs and air-conditioning plant, refrigeration, lighting, motors and controls, distributed generation plant, etc. for commercial customers.

The method of the invention allows for the replacement of load sampling and estimating processes with processes that utilize real-time data about energy use, system operations and resource capability. These new processes allow the utility energy procurement operators to more finely tune procurement management to keep costs as low as possible.

### Forecasting Energy Supply Requirements

The method of the invention provides the utility energy procurement managers with far more specific use data in acquisition frequencies up to and including real-time, replacing the current statistical sampling methodologies. This improved data can be incorporated into new forecasting processes that will then be used to tune and better optimize energy procurement thus reducing costs. Frequent updating of actual energy use data obtained via the method of the invention during periods of rapid changes in consumption (either increasing or decreasing compared to forecast) allows the utility procurement operators to refresh load forecasting models in near real-time and refine and optimize procurement actions.

### Characterize DER Assets for Economic Dispatch

The energy procurement planning process incorporates the availability and responsiveness of various existing load management and demand response programs that have been developed and deployed to allow management of end use load for economic dispatch purposes. Load management for economic dispatch purposes (as opposed to emergency response capability as discussed above) is a process wherein customers have agreed to, or will allow the utility to directly, modify or curtail energy use associated with equipment or systems beyond the customer meter for a specified price (usually a tariff-based incentive or discount) over a specified period of time. Energy supply planners try to optimize the power supply portfolio by integrating the forecast cost and availability of power from the market with the estimated availability and cost of these DER assets.

Currently a significant drawback and inefficiency associated with the use of customer demand response and curtailment programs as a resource in economic dispatch operations is the lack of explicit real-time knowledge available to utility dispatchers regarding the true availability of controllable resources behind the meter in conjunction with the actual responsiveness of customers under passive demand response programs following notification. Utility dispatchers often are required to go into the power market and make spot power purchases or sales when, in fact, expected response from customer resources differ significantly from expected and planned levels. This uncertainty results in utilities over or under purchasing by potentially significant margins at considerable costs, thus eroding significant value from the economic dispatch plan and raising costs to customers.

### Identify & Quantify Unaccounted-for-Energy

Currently, detailed information about energy consumption on the system is available in real-time only at the higher operational levels via the Supervisory Control and Data Acquisition (SCADA) and load management systems which provide system loading information at transmission interconnection points and some distribution substations. While this level of specificity provides guidance to utility operators, lack of real-time energy consumption data at the circuit and end user level leaves system dispatchers blind to rapid changes in locational consumption patterns and thus requires them to be conservative in procuring energy supplies. Moreover, on highly interconnected systems, there is a real problem associated with energy that is procured and delivered, but not fully accounted for at the end use level. This is commonly referred to as Unaccounted For Energy (UFE) and is not readily managed in real-time due to lack of detailed real-time data at these interconnection points in conjunction with lack of real-time consumption data at the end user locations. Because system operators cannot reconcile, in real time, delivery with end use consumption, UFE is unknown until end use meters are read, data assembled and compared to delivery. Only then is the quantity of energy procured and delivered reconciled with that delivered and billed, the difference being UFE.

The method of the invention enables better identification of UFE and better track, record and recoup these losses. Improved processes for energy accounting take advantage of the detailed, real-time information and enable identification of losses that may be occurring at interchange points with interconnected municipalities and utility systems or on distribution circuits.

### Optimize Energy Supply Portfolio

Use of the method of the invention takes advantage of the feedback provided by real-time monitoring of distribution system and specific customer loads to enable the utility to determine whether or not energy consumption for the day is following the forecast pattern or deviating significantly from that which was forecast. Combining the advanced utility meter with dynamic customer interfaces allows the utility to selectively request or curtail loads to reduce consumption on a real time basis and avoid unplanned and uneconomic spot purchases or sales.

The method of the invention also allows new tariffs to be developed and designed to influence customers to participate in programs that allow the utility to shed select load for economic management purposes and effectively avoid energy purchases during certain periods or at certain costs thresholds. This economic load shedding capability will be extended to offset otherwise required generation resources which the utility could control and operate. The firm economic load dropping capability itself may qualify to be categorized as a spinning reserve resource—effectively reducing generation capital expenditures.

One of the many features of the method of the invention includes the ability to remotely curtail energy usage at the meter panel itself. The curtailment capability can include the ability to remotely change the maximum energy consumption at any metered premise, at the discretion of the utility or other governing entity. This feature can be used to create value through a dynamic interface with individual meter loads to mitigate transmission level system instability. During an emergency event, when and if energy demand approaches a point of exceeding on-line generation resources, the system can react to reducing that peak-demand back to a level that can be supported during the required period of time.

These load curtailment system features also yield a far superior ability to mitigate or eliminate unplanned black-out conditions. If and when the energy demand exceeds generation capacity, utilities have resorted to dropping entire circuits in order to reduce system load. This forced outage can be extended to as many circuits (supplying energy to the end-use customers) as is required to achieve a capacity balance between supply and demand. Further, once this demand is intentionally or unintentionally forced off the grid, restoration can take a significant amount of time depending on resource availability and ramp-up conditions. By utilizing the curtailment capabilities that will exist though the envisioned advanced metering infrastructure, load can be surgically reduced on any given circuit, rather than dropping the entire circuit. This would give utilities significantly more control in managing the grid, provide the potential to completely avoid some possible blackout conditions, and better ensure that energy continues to flow to “critical customers” sites.

### Estimating Settlement Costs

Existing processes for acquiring actual energy use information have lag times of as much as 30-45 days past date of delivery. Energy supply operators must rely on estimates which may differ significantly from actual use. Substantial cost may be incurred when imbalance penalties are not known for such a delayed period. If imbalance use and charges were known in greater detail and in a more timely manner, available corrective actions for following day resource plans would be developed and put in place to minimize on going costs.

The method of the invention, by way of gathering detailed energy use data in real-time or on the following day, allows the utility to more accurately estimate government delivery and imbalance charges, such as California Independent System Operator (CA ISO) delivery and imbalance charges.

Market Operations prepares and submits bids and offers into the market. Bids and offers are evaluated against needs, offsetting bids and offers, and then accepted, matched, or rejected. The evaluated bids will lead to load curtailment when it is economically feasible, the matched bid and offer curtail load, instead of accepting the offers from supply side resources within the ancillary services market.

Each market relies on resource data that is updated and provided in advance of the decision making process. The resource data includes load forecast data, supply resource status and availability data. The data is presented for each and every hour for the day(s) in focus. The load forecast data, while complicated to determine, is represented fairly simply. In other words, there is an expected load for each and every hour presented to the day-ahead trader. The supply resource data is more complex. For each and every resource, which includes demand response programs, the marginal or incremental economics are presented. These economics depend upon whether the resource, or unit, is available and/or running. Then market price is layered into the decision-making process. The market price is the price at which electric supply can be bought (the ask) or sold (the bid). The market price can be a simple, single number, or it can be a complex, range of numbers.

Real-time is a simple reference to the market arena containing the ancillary service products, namely AGC (automatic generation control), spinning reserves, non-spinning reserves and replacement reserves.

The day-ahead market relies on resource data that is updated daily before trading begins. The data is presented in hourly detail. The data is gathered over several hours the day before and updates continue until approximately one-half hour before trading begins. After trading ends, the load and resource data are transferred over to generate schedules for reporting and clearing through the ISO (Independent System Operator).

The hour-head market relies on resource data that is updated throughout the day. The data is also presented in hourly detail. The data gathering continues throughout the day providing periodic reports that are integrated and used by the real-time trader. Generally, the hour-ahead market closes approximately three and a quarter hours before the electricity flows, and schedules are generated and cleared through the ISO.

The real-time markets containing the ancillary services rely on data that is gathered from as short as every 4 seconds to, 5 minutes, 10 minutes, and as long as hourly. The data intervals are, or should be, configurable independently of the gathering rate, or reporting rate, since the two are not strictly correlated. Generally, AGC is presented and gathered every 4 seconds. Spinning and non-spinning reserves are presented in 5 and 10 minute intervals and gathered in a potentially variable range between 5 and 60 minutes. Replacement reserves are generally presented and gathered in hourly intervals.

Market Operations prepares its resource stack by analyzing all resources available and presenting them in order from least cost, cheapest, to high cost, most expensive. Each time information changes (eg market price, resource status, etc.), market operations adjusts the resource stack for the next decision. The energy trader then compares the resource stack to the market price and the load forecast to determine whether the load will be met by market purchases or dispatching resources. If available resources are cheaper than the market, then resources will be dispatched until the load and or the market price are matched.

Demand response programs, load curtailment, may therefore become an option when it is economically feasible to curtail load instead of dispatching a more expensive resource or trading electricity at a higher market price.

Economic Dispatch is this overall process of dispatching required resources, or load curtailment, and trading market electricity such that the total cost of operation is minimized.

In relation to the method of the invention system the resource data for analysis is gathered by SCADA and/or the method of the invention.

A computer system known a Demand Response Availability And Control System (DRAACS) can provide a tool for Market Operations to manage demand response as another resource for economic dispatch. DRAACS analyzes the response from previous demand response requests and provides energy traders with an estimate of how much load could be reduced through demand response over a selected time period. The energy traders submit their economic dispatch requests to DRAACS, which coordinates them with any other pending requests, including requests from the Grid Control Center for reliability purposes.

DRAACS selects a set of customers whose response should satisfy the economic dispatch request. It sends load reduction requests to these customers, who usually have the option to participate or not, depending on their contract. Some customers may have subscribed for load limiting, in which case their advanced utility meter is permitted to disconnect their service if they do not meet the previously agreed threshold of load reduction.

DRAACS measures the aggregate load reduction and has the possibility to issue additional load reduction requests to selected customers. For this purpose the method of the invention system shall have multiple curtailment stages that can be activated and deactivated automatically based on curtailment requests from DRAACS.

The Energy Trader receives feedback on the success of the resource dispatch request through two channels:
The Energy Management System at the Grid Control Center provides DRAACS with aggregate data gathered through the SCADA system in real-time, i.e. at 4 second intervals. DRAACS uses this information immediately to determine whether another curtailment stage will be necessary.

When it has attempted all appropriate curtailment stages and has decided that no more demand response is likely, then DRAACS uses the aggregated SCADA information to supply the Energy Trader with indication of whether the dispatch request was successful. The trader can use this information to make decisions about upcoming market windows.
DRAACS receives more accurate feedback data from the AMI. This information includes which customers responded and by how much they reduced their load. DRAACS uses this information to improve its estimates for subsequent demand response requests. For most products, DRAACS receives this information the following day. However, for Spinning Reserves and AGC products, the AMI system must provide this more accurate data to DRAACS in real-time, with response times comparable to SCADA. This real-time feedback through AMI is also necessary for supporting the real-time validation required by the ISO.

Curtailment of load for economic dispatch through the method of the invention provides the following benefits to the utility:
By using interval metering, it is possible to more accurately verify actual customer response to specific events and avoid the need for load profiling. This permits the utility to properly report energy usage on the events that are bid into the ISO and avoid both the cost of the uninstructed energy and the cost of uninstructed deviation penalties
The utility can achieve considerable cost savings by reducing overshooting or undershooting in ISO bidding due to better load forecasting, based on more accurate data from the AMI system.

Market Operations receives and prepares bids and offers into the wholesale energy market and evaluates the incoming bids from the wholesale market against the needs and the cost of operation. To facilitate this process, Market Operations needs to know what resources, such as distributed generation or demand response, are available and for how long.

In a system without the method of the invention, resource information must be estimated from the historical load profiles averaged from a small set of selected meters.

The meters used to build the load profiles may or may not be the same meters involved in the wholesale market transaction.

Using the method of the invention, Market Operations acquires from the system the actual aggregate load measured by a particular subset of the utility's meters that are of interest to Market Operations. This subset of meters may, for instance, represent a single customer offering to supply distributed generation over a particular time period for a contracted price; or it may represent a number of customers who are offering through a third-party aggregator to reduce their load.

Using the method of the invention, Market Operations can make better decisions about which wholesale transactions to make because:
The measurements derived from the method of the invention are made from a sample better resembling the portion of the load that is the subject of the wholesale transaction, and,
The measurements derived from the method of the invention are taken very close in time to when the transaction will take place.

Sometime after a wholesale transaction has been completed, Market Operations settles the transaction using actual usage data gathered by the method of the invention during the period specified in the transaction. Data from the method of the invention is used to prepare bills and invoices to multiple parties involved in the transaction based on existing contracts and tariffs.

A specialized computer system known as the Distributed Resources Availability And Control System (DRAACS) serves as the interface between Market Operations and the AMI System comprising the method of the invention. The Load Forecasting group within Market Operations uses DRAACS to request that certain sets of meters record usage data at a higher rate than normal. Load Forecasting uses this specially sampled data to drive forecasting models and pricing curves, which it will use to evaluate incoming bids from the wholesale market.

DRAACS responds to the requests from Load Forecasting by remotely re-programming individual meters to record at higher “special” rates.

Approximately 1% of the utility's meters are polled at intervals smaller than one hour, in order to generate predictive load profiles based on common customer characteristics such as geography or climate. This “special rate” data is retrieved in time to be used in market forecasts for the next day.

In addition to generating these general next-day profiles, Load Forecasting also uses as input data gathered using the method of the invention from the same day the wholesale transaction is to be completed.

Load Forecasting asks DRAACS to sample this data at “hyper” intervals as small as every four seconds, from a much smaller subset of meters. DRAACS returns the aggregated load information within a few minutes. The Energy Trader, who is a member of Market Operations, uses forecasts generated from both the “hyper” and “special” samples to evaluate bids in “real-time” and complete transactions.

Sometime after the wholesale transaction is complete, information gathered from the method of the invention and elsewhere will be used in the settlement process to prepare bills and invoices to multiple parties based on contracts and tariffs. The data used for this settlement process is the actual data from the subset of meters specified in the transaction.

The value of using the method of the invention data, sampled at a higher than normal rate, to perform real-time load forecasting for the purposes of procuring energy and settling wholesale transactions is:

1. It produces higher accuracy for forecasts which reduces the risk and associated cost of forecasting error. The cost of forecast errors is presently unknown. Presently this cost is part of the overall cost of service and passed along to customers.

2. If the real time position at the time of the transaction can be known more accurately then there is the potential that the amount of energy sold into the ex-post market unknowingly can be reduced such that millions in potential annual savings may be achieved.

3. There are marketability issues associated with load forecasting error and the ex-post market. These ex-post market issues expose the utility to liquidity risks. There is cost risks associated with buying/selling into the real-time market because price is unknown and it is a small market. Due to the volume of energy transacted in the ex-post market, the purchase or sale is more costly than the hour-ahead or day-ahead market where there is more control over what is being bought/sold.

Capturing high-rate interval data will significantly increase the quality of the meter data reported to the ISO today and will provide a more accurate estimate of the actual cost of the energy.

Having thus described the invention, it should be apparent that numerous structural modifications and adaptations may be resorted to without departing from the scope and fair meaning of the instant invention.

1. A method for communicating between a utility and individual customer locations comprising the steps of:
(a) communicating between the utility and customers and between the utility and customer equipment located at each individual customer location via the Internet or via an advanced utility meter;
(b) providing each individual customer location with an advanced utility meter; and
(c) using each individual utility meter to communicate between the utility and the advanced utility meter, to communicate between the advanced utility meter and individual customers and to communicate between the advanced utility meter and equipment located at each individual customer location;
wherein the utility is an electrical utility and wherein electrical usage data from individual pieces of equipment located at each individual customer location is communicated to the advanced utility meter.

2. (canceled)

3. The method of claim 1 wherein the advanced utility meter communicates between multiple pieces of equipment located at each individual customer location.

4. The method of claim 1 wherein the utility is an electrical utility and wherein each advanced utility meter collects data at least as often as once per hour.

5. The method of claim 1 the utility is an electrical utility and wherein each advanced utility meter communicates to the utility at least as often as once per day.

6. (canceled)

7. The method of claim 1 wherein the utility is an electrical utility and wherein each advanced utility meter communicates instructions to one or more electrical usage controllers located at the individual customer location.

8. The method of claim 1 wherein the utility is an electrical utility and wherein the advanced utility meter comprises a remote service connect/disconnect switch or a remote current limiting device activation/deactivation switch.

9. The method of claim 1 wherein each advanced utility meter communicates upgrades and maintenance directives to communications software, monitoring software, storage software or controller software located at the individual customer location.

10. The method of claim 1 wherein each advanced utility meter comprises means for two-way communication with each individual customer.

11. The method of claim 1 wherein the communications between each advanced utility meter and individual customers or equipment located at individual customer location is accomplished via wireless communications equipment.

12. The method of claim 1 wherein each advanced utility meter communicates with individual customers via a display device.

13. The method of claim 1 wherein usage, billing and cost data is communicated between each advanced utility meter and each customer.

14. The method of claim 1 wherein each advanced utility meter comprises storage means for storing data.

15. A method for communicating between an electrical utility and individual customer locations comprising the steps of:
(a) providing each individual customer location with an advanced utility meter, the advanced utility meter comprising means for two-way communication with each individual customer and storage means for storing data; and
(b) using each individual utility meter to communicate between the utility and the advanced utility meter, between the advanced utility meter and multiple pieces of individual customers and between the advanced utility meter and equipment located at each individual customer location;
wherein electrical usage data from individual pieces of equipment located at each individual customer location is communicated to the advanced utility meter;
wherein each advanced utility meter communicates instructions to one or more electrical usage controllers located at the individual customer location;
wherein each advanced utility meter communicates upgrades and maintenance directives to communications software, monitoring software, storage software or controller software located at each individual customer location; and
wherein each advanced utility meter communicates usage, billing and cost data between the utility and each customer location.

16. A system for communicating between a utility and individual customer locations, the system comprising:
(a) individual input and output portals disposed at each individual customer location;
(b) a data center aggregator for gathering data from each individual customer location and for retransmission to the utility, and for disseminating data and instructions from the utility to each customer location;
(c) a data management system for sorting data from the data center aggregator, for transmitting data to individual back office systems within the utility and for transmitting data and instructions from individual back office systems to each individual customer location; and
(d) means for communicating between the utility, the data center aggregator, the data management system and the input and output portals disposed at individual customer locations.

17. The system of claim 16 wherein the input and output portals comprise a portion of an advanced utility meter disposed at each individual customer location.

18. The system of claim 16 wherein the means for communicating between the utility, the data center aggregator, the data management system and the input and output portals comprises the Internet.
